(19) United States
(12) Patent Application Publication
(10) Pub. No.: US 2005/0082973 A1
(43) Pub. Date: Apr. 21, 2005

(54) [IMPROVED STRUCTURE OF LED]

(75) Inventor: JUI-TUAN LI, TAIPEI (TW)

Correspondence Address: JOINSCAN ELECTRONICS CO., LTD., P.O. BOX 108-00403, TAIPEI, TW

(73) Assignee: JOINSCAN ELECTRONICS CO., LTD, HSIN-CHIH, TAIPEI HSIEN, (TW)

(21) Appl. No.: 10/905,184

(22) Filed: Dec. 21, 2004

Related U.S. Application Data
(63) Continuation-in-part of application No. 10/680,092, filed on Oct. 8, 2003.

(51) Int. Cl. H01J 1/62

(52) U.S. Cl. 313/512; 313/483

(57) ABSTRACT

A light emitting diode includes a frame, which has fist leg, a second leg, a chip bonded to the top end of the first leg, and an electrode wire soldered between the chip and the top end of the second leg, and a resin layer, which packages the chip and the electrode wire and has a fluorescent layer evenly distributed in between a first resin layer and a second resin layer thereof for enabling light source from the chip to be fully mixed with the color of the fluorescent material in the fluorescent layer to produce the designed color of light.

This application is a continuation-In-Part of my patent application, Ser. No. 10/680,092, filed on Oct. 8, 2003.

### BACKGROUND OF THE INVENTION

1. Field of the Invention

The present invention relates generally to a light emitting diode and more particularly, to an improved structure of light emitting diode, which has the fluorescent layer bonded in between two resin layers that package the chip and the electrode wire, preventing fading of the fluorescent material due to heat from the chip.

2. Description of the Related Art

Following fast development of semiconductor technology, a variety of chip LEDs (light emitting diodes) have been disclosed and intensively used in different fields to substitute for conventional lamp bulbs. For example, many traffic and signal lights use LEDs instead of conventional lamp bulbs for the advantages of low consumption of electric energy and long service life.

Regular LEDs include red, yellow, green, and blue colors. There are also LED manufacturers who coat the resin layer with a fluorescent compound to change the color of the diode into, for example, white color, pink, or purple.

FIGS. 5 and 6 show the fabrication of a color LED according to the prior art. As illustrated, a LED chip A3 is bonded to one leg, namely, a first leg A1 of a frame A, and then an electrode wire A4 is soldered to the LED chip A3 and the other leg, namely, a second leg A2 of the frame A, and then a first resin layer A5 is molded on the first leg A1, and then a fluorescent layer A6 is molded on the LED chip A3, and then a resin layer A7 is molded on the frame A to have the LED chip A3 and the electrode wire A4 and the fluorescent layer A6 embedded therein.

The aforesaid LED fabrication method has numerous drawbacks as outlined hereinafter.

1. A sedimentation effect will occur before hardening of the fluorescent material or resin containing a fluorescent material that is coated on the LED chip, thereby resulting in an uneven layer of fluorescent material on the outside wall of the LED chip.

2. Uneven coating of the fluorescent material on the LED chip results in incomplete mixing of light with the fluorescent material and poor quality of white light.

3. Heat from LED chip directly transmits to the fluorescent material, thereby causing the fluorescent material to fad quickly with use.

4. Because the fluorescent material is directly coated on the LED chip, no distance is kept between the LED chip and the fluorescent material for allowing light from the LED chip to be well mixed with the color in the fluorescent material to provide the designed color of light.

### SUMARRY OF THE INVENTION

The present invention has been accomplished under the circumstances in view. It is therefore the main object of the present invention to provide a light emitting diode, which keeps the fluorescent layer well protected against heat from the chip, preventing fading of the fluorescent material. To achieve this and other objects of the present invention, the light emitting diode comprises a frame and a resin layer molded on the frame. The frame comprises a first leg, a second leg, a chip bonded to the top end of the first leg, and an electrode wire, which has a first end soldered to the chip and a second end soldered to the second leg. The resin layer is molded on a part of the frame and covered on the chip and the electrode wire, comprising a first resin layer, a second resin layer, and a fluorescent layer bonded in between the first resin layer and the second resin layer. The resin layers protect the fluorescent layer against heat from the chip, enabling light from the chip to be fully mixed with the color of the fluorescent material in the fluorescent layer to provide the designed color of light.

### BRIEF DESCRIPTION OF THE DRAWINGS

FIG. 1 is a perspective view of a light emitting diode according to the first embodiment of the present invention.

FIG. 2 is an exploded view in an enlarged scale of a part of the first embodiment of the present invention before molding of the resin covering.

FIG. 3 is a manufacturing flow of the light emitting diode according to the first embodiment of the present invention.

FIG. 4 is a manufacturing flow of the light emitting diode according to the second embodiment of the present invention.

FIG. 5 is an exploded view of a part of a light emitting diode according to the prior art.

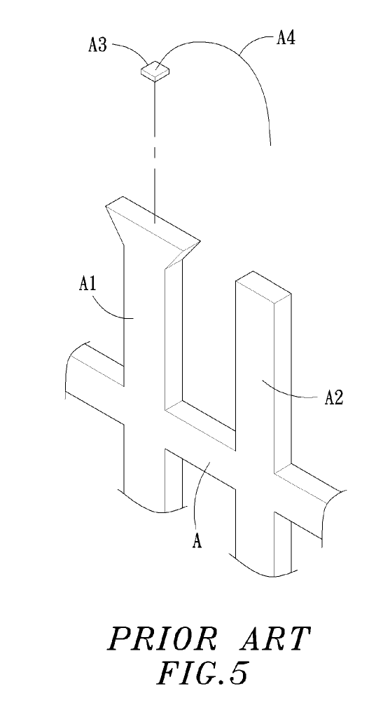

FIG. 6 is a manufacturing flow of the light emitting diode according to the prior art.

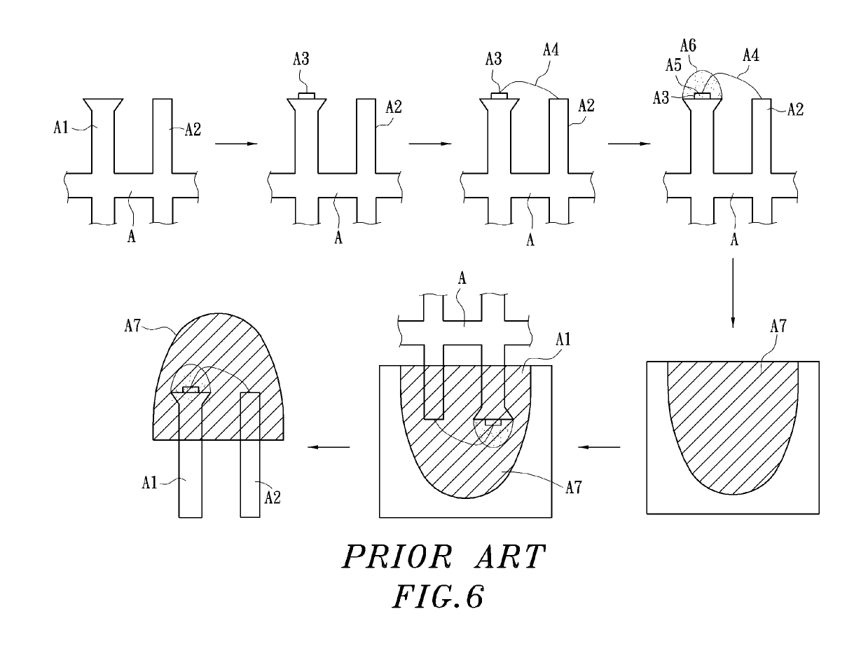

### DETAILED DESCRIPTION OF THE INVENTION

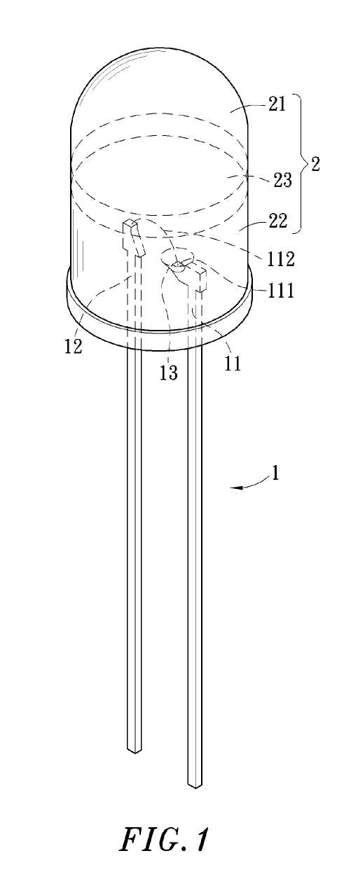

Referring to FIGS. 1˜3, a light emitting diode in accordance with the first embodiment of the first embodiment of the present invention is shown comprising a frame 1, and a resin layer 2.

The frame 1 comprises a first leg 11, a second leg 12 corresponding to the first leg 11, a chip 111 bonded to the first leg 11, and an electrode wire 112 having two distal ends respectively soldered to the chip 111 and the second leg 12 to electrically connect the legs 111 and 12. The resin layer 2 covers a part of the frame 1, keeping the chip 111 and the electrode wire 112 embedded therein. The resin layer 2 comprises a first resin layer 21, a second resin layer 22, and a fluorescent layer 23 bonded in between the first resin layer 21 and the second resin layer 22 and spaced from the chip 111 at a distance. The fluorescent layer 23 is evenly distributed over the respective bonding surface of the first resin layer 21 and the second resin layer 22.

The fluorescent layer 23 contains a fluorescent material, which can be prepared from yellow, pink, red, green or blue color fluorescent power or flakes, or their combination. When in use, the chip 111 gives off light that passes through the resin layer 2. When passing through the fluorescent layer 23, the light changes to the designed color.

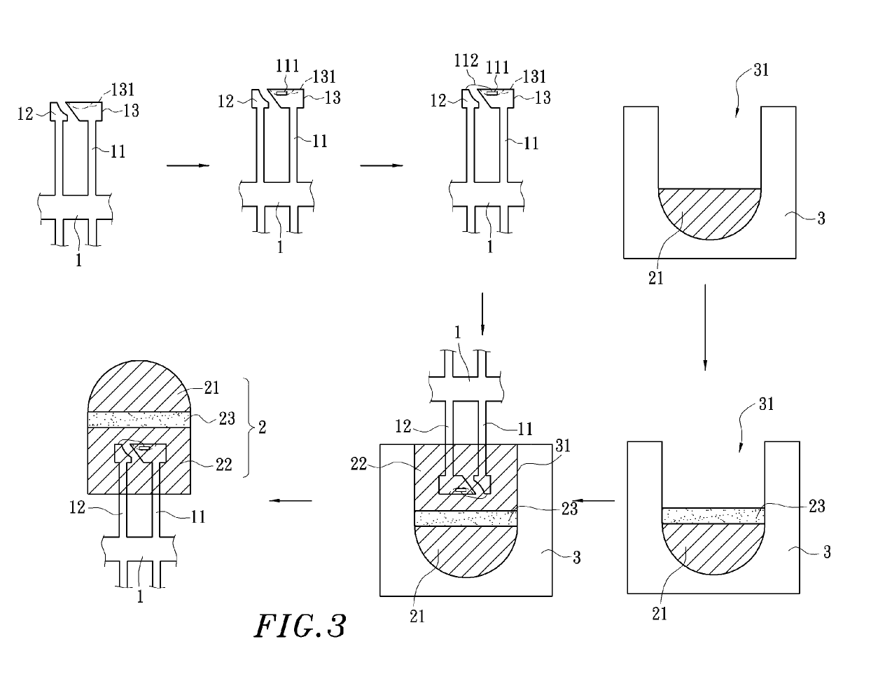

The molding of the resin layer 2 is described hereinafter with reference to FIG. 3. A resin material for the first resin layer 21 is filled in a cavity 31 of a mold 3, and then the prepared fluorescent material for the fluorescent layer 23 is filled in the cavity 31 of the mold 3 over the top side of the resin material for the first resin layer 21, and then resin material for the second resin layer 22 is filled in the cavity 31 of the mold 3, keeping the fluorescent material for the fluorescent layer 23 in between the resin material for the first resin layer 21 and the resin material for the second resin layer 22.

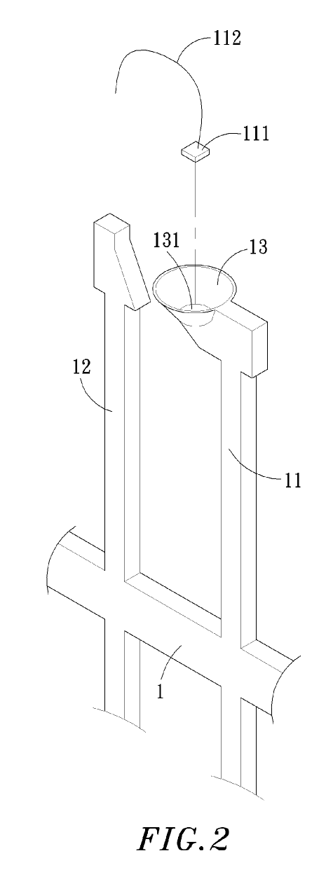

Referring to FIGS. 2 and 3 again, the first leg 11 has a cup-like receptacle 13 formed integral with the top end thereof. The receptacle 13 defines a receiving chamber 131 for accommodating the chip 111. The chip 111 is positively bonded to the inside wall of the receptacle 13.

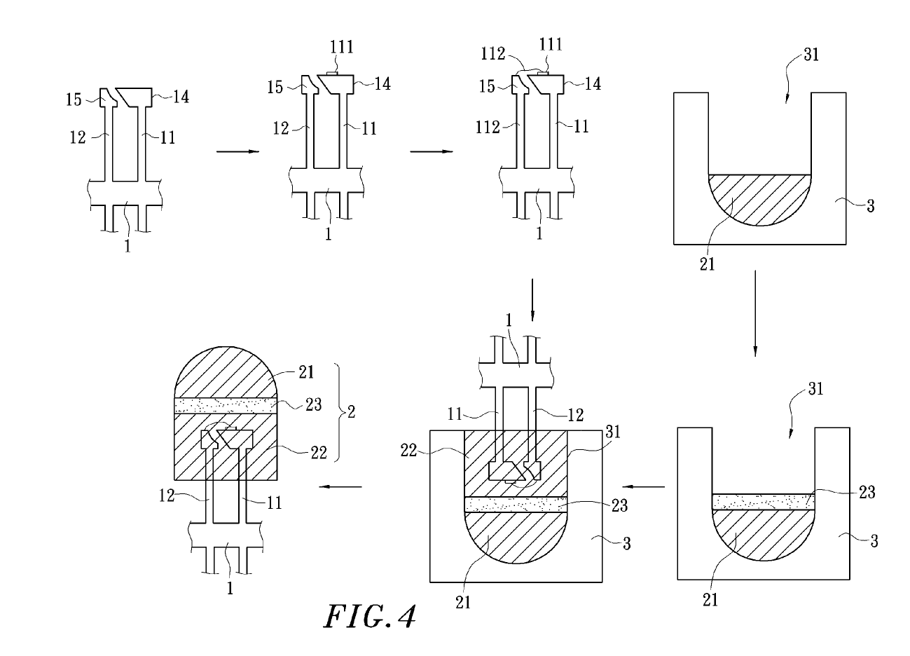

FIG. 4 shows the fabrication on a light emitting diode according to the second embodiment of the present invention. According to this embodiment, the first leg 111 has a top bonding endpiece 14 for the bonding of the chip 111; the second leg 12 has a top soldering endpiece 15; the electrode wire 112 has one end soldered to the chip 111 at the top bonding endpiece 14 of the first leg 111 and the other end soldered to the top soldering endpiece 15 of the second leg 12. Similar to the aforesaid first embodiment of the present invention, the resin layer 2 according to this second embodiment comprises a first resin layer 21, a second resin layer 22, and a fluorescent layer 23 bonded in between the first resin layer 21 and the second resin layer 22. The fluorescent layer 23 can be prepared from yellow, pink, red, green or blue color fluorescent power or flakes, or their combination.

As indicated above, a light emitting diode made according to the present invention has the following advantages:

1. During packaging process to pack the chip with the resin layer, the fluorescent layer is bonded in between the first resin layer and the second resin layer, keeping the fluorescent layer evenly distributed in the resin layer.

2. The fluorescent layer is evenly distributed in the resin layer between the first resin layer and the second resin layer so that the color of the fluorescent layer can be fully mixed with light source from the chip to produce the designed color of light.

3. The second resin layer keeps the fluorescent layer away from the chip, preventing fading due to heat, and therefore the service life of the light emitting diode is prolonged.

4. A proper distance is kept between the fluorescent layer and the chip so that light source from the chip can be fully mixed with the color of the fluorescent layer to emit the designed color of light.

Although particular embodiments of the invention have been described in detail for purposes of illustration, various modifications and enhancements may be made without departing from the spirit and scope of the invention. Accordingly, the invention is not to be limited except as by the appended claims.

1. A light emitting diode comprising a frame, said frame comprising a first leg, a second leg, a chip bonded to said first leg, and an electrode wire, said electrode wire having a first end soldered to said chip and a second end soldered to said second leg, and a resin layer molded on a part of said frame and covering said chip and said electrode wire, wherein said resin layer comprises a first resin layer, a second resin layer, and a fluorescent layer bonded in between said first resin layer and said second resin layer.

2. The light emitting diode as claimed in claim 1, wherein said fluorescent layer is evenly distributed over a bonding surface of said first resin layer and a bonding surface of said second resin layer.

3. The light emitting diode as claimed in claim 1, wherein said fluorescent layer is prepared from a fluorescent material having multiple colors including yellow, pink, red, green, and blue.

4. The light emitting diode as claimed in claim 3, wherein said fluorescent material is a fluorescent powder.

5. The light emitting diode as claimed in claim 3, wherein said fluorescent material is comprised of fluorescent flakes.

6. The light emitting diode as claimed in claim 1, wherein said first leg has a top end terminating at a receptacle for accommodating said chip.

7. The light emitting diode as claimed in claim 6, wherein said receptacle has the shape of a cup.

8. The light emitting diode as claimed in claim 1, wherein said first leg has a top end terminating at a bonding endpiece for the bonding of said chip; said second leg has a top end terminating at a soldering endpiece for the bonding of said electrode wire.
